(19) United States
(12) Patent Application Publication
(10) Pub. No.: US 2020/0380856 A1
(43) Pub. Date: Dec. 3, 2020

(54) REMOTE POSITION CONTROL SYSTEM

(71) Applicant: Michael Hetherington, Williamston, MI (US)

(72) Inventor: Michael Hetherington, Williamston, MI (US)

(21) Appl. No.: 16/876,536

(22) Filed: May 18, 2020

Related U.S. Application Data
(60) Provisional application No. 62/853,440, filed on May 28, 2019.

(51) Int. Cl. G08C 21/00

(52) U.S. Cl. CPC G08C 21/00

(57) ABSTRACT

“Mouse-like” positional controls are implemented in a joystick-style human interface. Pan and tilt movements are sensed with electronic encoders, and coordinates are transmitted in wired or wireless fashion to aim a camera, light or other utilization device. A spring may be used to return the grip handle to center or neutral position with no “positive” center. Devices according to the invention are trigger-activated, enabling continued transmission positional information when the lever reaches physical limits. The handle is coupled to a lever arm, with pan-axis pivoting being sensed at its proximal end, with tilt-axis pivoting being detected where the handle couples to the lever at it distal end. Thumb buttons/controls may be provided on the grip handle, and an arm rest may be used as an arm rest over the pan-axis pivot. An alternative embodiment incorporates a hand grip attached to a base that slides on a surface to sense x-y motion.

### REFERENCE TO RELATED APPLICATIONS

This application claims priority to, and the benefit of, U.S. Provisional Patent Application Ser. No. 62/853,440, filed May 28, 2019, the entire content of which is incorporated herein by reference.

### FIELD OF THE INVENTION

This invention relates generally to remote position control systems and, in particular, to control device systems, devices and methods based on a computer mouse paradigm, using a position-position relation to aim a remote object, as opposed to more traditional joystick modalities.

### BACKGROUND OF THE INVENTION

Traditional joysticks and position control devices such as the computer mouse and trackpads are based on disparate functionality. Joysticks detect movement is two (or three) dimensions, and translate direction into positional control regardless of precise coordinates. As such, joysticks have been used for civilian and military aircraft flight control video games, and control of machines such as cranes, trucks, underwater unmanned vehicles, wheelchairs, surveillance cameras, and zero-turn-radius lawn mowers.

The mouse/trackpad paradigm instead uses position-to-position control based upon actual sensed coordinates. Mouse/trackball control is inherently more accurate that joystick control, and is therefore favored for computer screen and cursor control movements. While it would be beneficial to use a computer mouse to control a remote device such as a camera for enhanced accuracy, the use of a mouse for remote control tends to be physically awkward.

### SUMMARY OF THE INVENTION

This invention improves upon remote control and aiming systems and methods by implementing mouse-like positional control in a joystick-style human interface. The result is a device that is easy to use and inexpensive to engineer while being accurate and versatile.

In preferred embodiments, control devices constructed in accordance with the invention embody “mouse-like” position-to-position control in a grip-handle format. Pan and tilt movements are sensed with electronic encoders, and coordinates are transmitted in wired or wireless fashion to aim a camera, light or other utilization device.

In some embodiments, a spring may be used to return the grip handle to center or neutral position with no “positive” center. Devices according to the invention are trigger-activated, enabling continued transmission positional information when the lever reaches physical limits. The handle is coupled to a lever arm, with pan-axis pivoting being sensed at its proximal end, with tilt-axis pivoting being detected where the handle couples to the lever at it distal end.

The grip handle is free to rotate its vertical axis. Thumb buttons/controls may be provided on an upper surface of the grip handle, and an arm rest may be used as a user support above and over the pan-axis pivot. An alternative embodiment incorporates a hand grip attached to a base that slides on a surface to sense x-y motion.

### BRIEF DESCRIPTION OF THE DRAWINGS

FIG. 1 is an oblique view of a preferred embodiment of the invention;

FIG. 2 shows an arm rest provided in conjunction with the embodiment of FIG. 1;

FIG. 3 is a simplified block diagram that illustrates important electrical and electro-mechanical aspects of a system using the device of FIGS. 1, 2;

FIG. 4A is a drawing that illustrates an alternative embodiment of the invention that incorporates a hand grip attached to a base that slides on a surface to sense x-y motion that is used to control a remote device when a trigger on the grip is depressed;

FIG. 4B is a different view of the embodiment of FIG. 4A depicting sliding pads and an optical position sensor similar to a computer mouse; and

FIG. 4C shows a trigger that has two stages to allow further motion that activates a second switch to change the device control from a direct position based motion to a continuous motion in the speed and direction of the hand grip when the trigger is pulled into the second stage.

### DETAILED DESCRIPTION OF THE PREFERRED EMBODIMENTS

This invention is directed to a position control system and method for various applications that involve aiming a remote device, including remote camera control and lighting. The system at least includes a mechanical control lever operated by a human hand, and sensing electronics that sends position data to be used for aiming the remote device. The system may further include the remote device, as well as any intervening hardware or software modules operative to facilitate the position control functionality. In preferred embodiments, the position data is sent to the remote device, and the remote device reacts, in real time.

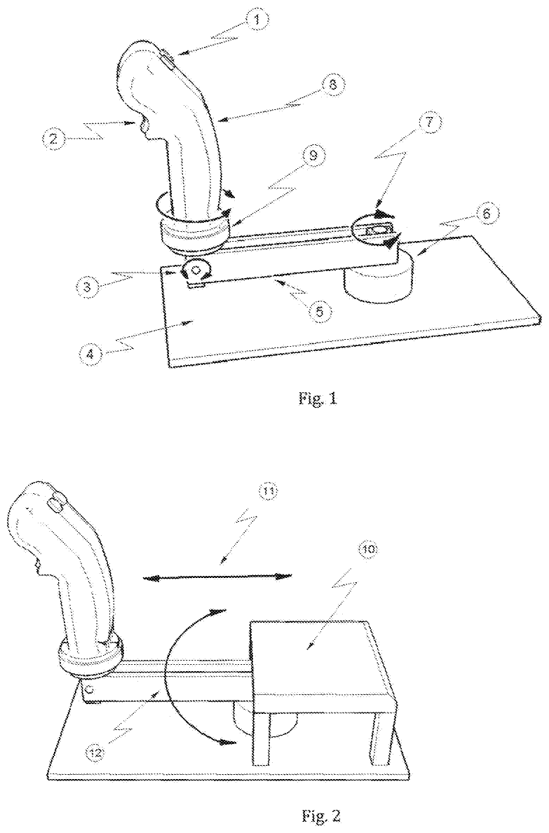

FIG. 1 is a drawing that illustrates a preferred embodiment of a control lever according to the invention. The apparatus comprises a grip handle 8, mounted on a pivoting arm 5, connected to a fixed base 4 through a bearing 6 and position sensing elements. The grip handle has a trigger 2, and may further include additional user controls. For example, the top portion of the control grip may include thumb-operated controls 1 in the form of buttons, rockers or sliders, for example, placed so that they may be conveniently operated while griping the handle, with or without the trigger 2 being engaged.

The grip handle pivots 3 on a vertical plane perpendicular to the arm 5 with a bearing and other position sensing elements. The grip handle pivot 3, and the arm pivot 7 each have an internal spring to return the handle and arm to a neutral or “center” position. These springs are designed such that there is very little force as they approach the center position, allowing for smooth operation around this position. The control lever is designed to prevent fatigue and to responsive in the center where the fine detail of aiming is required. The grip handle is mounted on a shaft 9 and is allowed to rotate to compensate for angular differences as the operator moves the lever arm side to side.

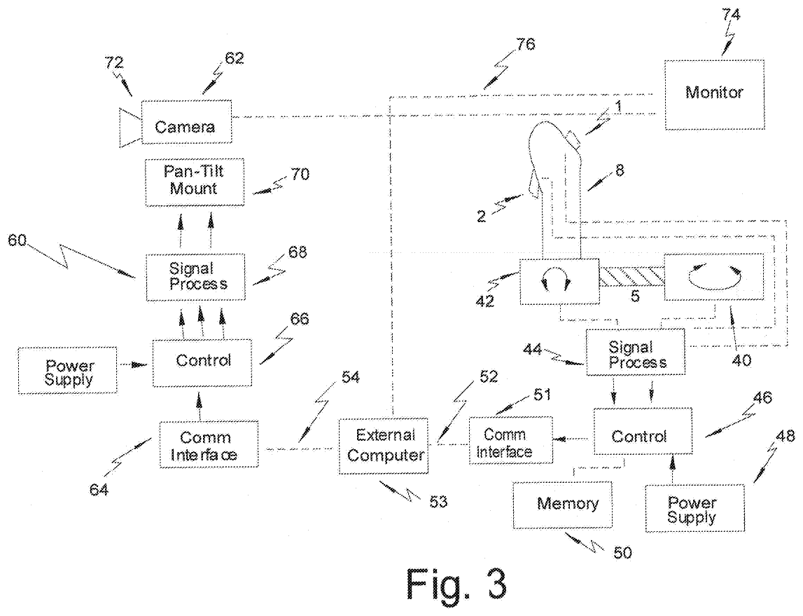

As shown in FIG. 2, the device may also include an adjustable arm resting surface 10 to allow the weight of the operators arm to be supported during operation. The pan axis 12 positioned under the operator's arm is independent of the tilt axis 11 positioned near the operator's wrist. The handle can freely rotate about its own vertical axis to prevent sideways twisting of the wrist during a panning movement. The optional arm rest 10 supports the weight of the operator's arm while moving the control lever.

The control lever is based on a computer mouse paradigm, using a position-position relation to aim the remote object, rather than the more traditional joystick, which implements a position-speed relation. The position data is only transmitted to the remote device when the trigger on the grip is activated. This allows the control lever to be spring-returned to center or neutral position without having to re-position the remote device being aimed.

In addition, the physical limits of the fore-aft motion 11 and the side-to-side motion (12) are known from the position sensing elements associated with the pivots 3, 7. This enables the control lever to continue sending positional information to a remote-controlled object even after the physical limits are reached as long as the trigger 2 is depressed, so that the physical limits of the control system do not stop the motion of the remote object, if desired. This is important if the aiming angles of the remotely controlled device are greater than the physical angles of the control lever. For example, while the control lever may exhibit have about a 45-degree swing and pitch, the remote device may have a considerably larger range. This is well managed by continuing to transmit the direction and speed when the control lever reaches its limit(s). As soon as the lever leaves the limit in the opposite direction or the trigger is released the transmission stops.

It should be noted that while two pivots are shown, other degrees of freedom are possible in accordance with the invention. For example, angular rotation of grip handle 8 in a plane perpendicular or transverse to the axis of arm 5 may also be measured and used for remote control, aiming, etc.

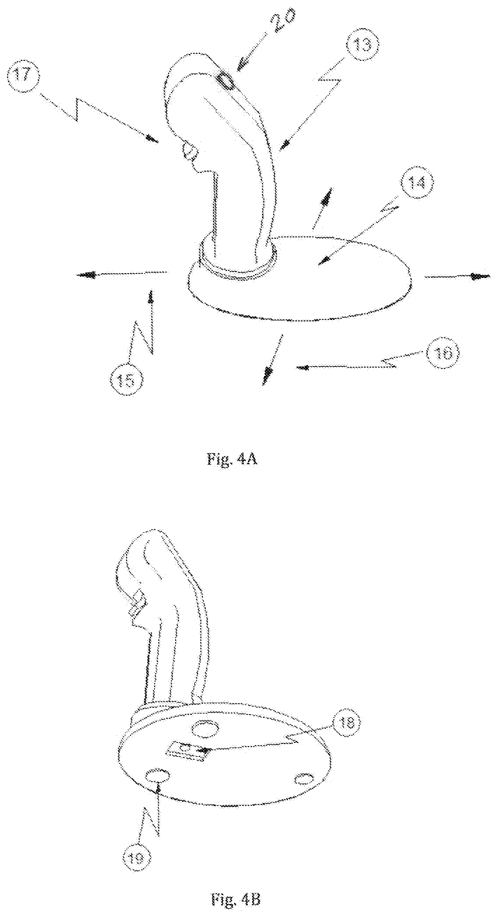

FIG. 3 is a simplified block diagram that illustrates important electrical and electro-mechanical aspects of a system using the device of FIGS. 1, 2. Electronic components may conveniently be disposed in fixed base unit 4. A first position sensor 40 is used to sense panning motion associated with arm 5, and second position sensor 42 is used to sense forward and back tilting motion of handle 8. These position sensors, being operative to sense rotational movements at pivots 3, 7 may include any appropriate type of mechanical or optical encoder, including the moving dielectric, capacitive position sensor configurations described in U.S. Pat. No. 7,602,376, the entire content of which is incorporated herein by reference.

The electrical signals generated by position sensors 40, 42 are delivered to signal processing electronics 44 to perform any required or desired amplification, level shifting or analog-to-digital conversions. Modified position-related signals are then input to microcontroller 46, a processor which may be a proprietary design or implemented with a conventional, commercially available integrated circuit, controls further system functions. In particular, processor 46 formats position information derived from sensors 40, 42 in conjunction with an integrated or separate communications interface 51 for receipt by an external computer 53 for further processing and/or to the utilization device 60.

Memory 50, which may be integrated into processor 46 or implemented separately, may include stored programs to control the functioning of processor 46 as well as data important to system control. For example, memory 50 may store information relating to the physical limits of the fore-aft motion 11 and the side-to-side motion 12 associated with the pivots 3, 7. This enables the control device to continue to deliver positional information to the utilization device even after stops are reached as long as trigger 2 is depressed. Power supply 48, which provides power to all active components, may be line- or battery-operated.

Information derived from pivots 3, 7 and additional input control information from trigger 2 and/or control(s) 1, is formatted by processor 46 and delivered as data messages for remote controlled object(s) such as camera 62 directly or through an external computer 53 which in turn sends data messages 54 to the remote controlled object(s). This information 52 and 54 may be sent with standard computer protocols through wired or wireless connections such as USB, Ethernet, Wi-Fi, RS232, RS485 or Bluetooth. The received information is processed by communications interface 64, and a separate or integrated processor 66 interprets these messages to position the remote object accordingly. In particular, movement control signals may be modified as necessary at block 68 and delivered to an electro-mechanical hardware such as pan-tilt mount 70. Pan-tilt mount 70 may be of conventional design using stepper motors, for example. Lens 72 on camera 62 may be a zoom lens, in which case the zoom function may be controller by control(s) 1 on handle 8.

It should be noted that while a camera 62 is shown in FIG. 3, item 62 should be taken to include any type of device that may take advantage of remote “aiming,” including lights or lighting, weapons control, and so forth. In addition, the purpose of the utilization device is not limited by the invention in the sense that a camera may be used for entertainment, news gathering, surveillance, etc. In the use of a camera, a video signal may be provided to a monitor 74 at the location of a remote user to provide feedback regarding use of the control device. Such a video signal may be delivered through path 54 as a two-dimensional path, or separate wired or wireless connection 76 may be implemented.

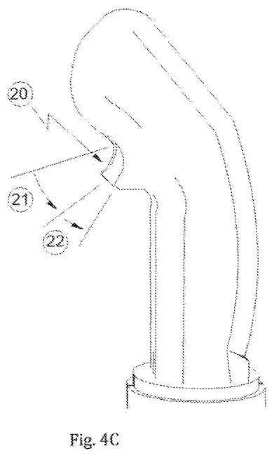

FIGS. 4A-C illustrate an alternative embodiment of the invention wherein a hand grip 13 attached to a base 14 slides on a surface such as a table to achieve x-y motion 15, 16 that is used to control the motion of a remote device when the trigger 17 is held. As with the embodiment of FIGS. 1-3, one or more user controls 20 may be mounted on the grip 13. As Shown in FIG. 4B, the hand grip has sliding pads 19 and an optical position sensor 18 similar to a computer mouse.

In FIG. 4C, the trigger 20 has two stages to allow further motion 22 that activates a second switch to change the device control from a direct position based motion to a continuous motion in the speed and direction of the hand grip when the trigger is pulled into the second stage. When released back to the first stage 21 the motion control returns to the position based motion and when completely released the motion of the remote device is not controlled by the hand grip.

1. A system for aiming a remote device, comprising:
a control lever responsive to side-to-side and fore-aft movements by an operator;
electronic circuitry operative to sense the side-to-side movements and send positional information to pan the aiming of the remote device based upon the side-to-side movements; and
electronic circuitry operative to sense the fore-aft movements and send positional information to tilt the aiming of the remote device based upon the fore-aft movements.

2. The system of claim 1, further including a trigger on the control lever such that the positional information is only sent to the remote device when the trigger is activated.

3. The system of claim 1, further including a horizontal arm having proximal and distal ends;
wherein the proximal end of the arm pivots about a vertical axis in conjunction with the side-to-side movements; and
the control lever pivots forward and back on the distal end of the arm in conjunction with the fore-aft movements.

4. The system of claim 3, wherein one or both of the pivoting of the arm and control lever have physical limits.

5. The system of claim 4, wherein the positional information continues to be send to the remote device upon reaching one of the limits if the trigger is activated.

6. The system of claim 1, including one or more springs to return the arm to a center or neutral position in the absence of side-to-side and fore-aft movements.

7. The system of claim 1, further including one or more thumb-operated user controls on the control lever; and
wherein the information sent to the remote device includes information regarding the status of the one or more thumb-operated user controls.

8. The system of claim 1, wherein the control lever is twistable about a generally vertical axis.

9. The system of claim 1, wherein the side-to-side movements are based on an operator's arm movements and the fore-aft movements are based on an operator's wrist movements.

10. The system of claim 9, further including an arm rest for an operator.

11. The system of claim 1, wherein the remote device is a camera.

12. The system of claim 1, wherein the remote device is a light.

13. The system of claim 1, wherein the remote device is a weapon.

14. The system of claim 1, wherein:
the control lever rigidly mounted on a base adapted to slide on a surface;
an optical position sensor between the base and the surface; and
the positional information to pan the aiming of the remote device is based upon side-to-side movements of the base relative to the surface; and
the positional information to tilt the aiming of the remote device is based upon forward-and-backward movements of the base relative to the surface.

15. The system of claim 14, further including a trigger on the control lever such that the positional information is only sent to the remote device when the trigger is activated.

16. The system of claim 14, wherein the trigger has two stages to change the remote device control from a direct position based motion to a continuous motion in the speed and direction of the hand grip when the trigger is pulled into the second stage.
